(19) United States
(12) Patent Application Publication
(10) Pub. No.: US 2014/0158207 A1
(43) Pub. Date: Jun. 12, 2014

(54) INTEGRATED BLOWING DEVICE

(71) Applicant: PRECITECH LLC, Washington, DC (US)

(72) Inventors: Laurent A. Rosec, Washington, DC (US); Yves Romanet, Sonnay (FR)

(73) Assignee: PRECITECH LLC, Washington, DC (US)

(21) Appl. No.: 13/712,164

(22) Filed: Dec. 12, 2012

(51) Int. Cl. B01F 1/00

(52) U.S. Cl. CPC B01F 1/0027
USPC 137/1; 137/268

(57) ABSTRACT

The present invention relates generally to systems and equipment for the handling and dispersal of bulk materials. Specifically, the invention relates to a pneumatic device for the handling of bulk materials which integrates the pneumatic power generating component and the material feeding component into a single device.

### FIELD OF THE INVENTION

The present invention relates generally to systems and equipment for the handling and dispersal of bulk materials. Specifically, the invention relates to a pneumatic device for the handling of bulk materials which integrates the pneumatic power generating component and the material feeding component into a single device.

### BACKGROUND OF THE INVENTION

A main way of spreading bulk materials, such as soil, sand, mulch, stone, straw, powders, or similar materials is through the use of pneumatic pressure. Such a method involves propelling a given material with air pressure, by either mixing the material in an air stream or by simply applying the air to the material. Traditionally, there are two basic systems that accomplish this method.

First, there is a system where there is a sealed container with the material that is to be handled. The container is pressurized with a pneumatic generation source (i.e. an air compressor), causing the air and the product to flow out through an outlet in the container. Typically this type of system is only useful for light materials such as powders. Second, there is system where an auger or other mechanism feeds the product in a chamber or airlock where the material is added to an air stream. The air stream is generated by a compressor or turbine and is mechanically separate from the material feeding system. This type of system is used for more bulky and dense materials.

The above mentioned systems, however, are inefficient, large, and expensive. For example for the first system, which utilizes a pressurized container, the container and equipment to pressurize it is expensive to fabricate and maintain. Moreover, that system is limited to handling only powder-like materials. As to the second system, while it can handle larger and denser materials, the system is complicated and power inefficient. This is because the second system has multiple components that each require separate power sources. Additionally, additional numbers of components creates reliability issues, as there are a greater number of components that can fail.

Therefore there is a need in the art for a pneumatic material handling device that can handle any type of material while efficiently incorporating both the material handling and the pneumatic components into a single streamlined device. These and other features and advantages of the present invention will be explained and will become obvious to one skilled in the art through the summary of the invention that follows.

### SUMMARY OF THE INVENTION

Accordingly, it is an object of present invention to provide a streamlined pneumatic bulk materials conveying system which incorporates into one apparatus the ability to simultaneously generate pneumatic power and provide material to the generated air stream for dispersal.

According to an embodiment of the present invention, an integrated blowing device includes: a material dispersal unit, comprising a, dispersal unit drive mechanism, an air chamber, an air turbine, a material chamber, a material turbine, and a dispersal outlet tube, wherein in said dispersal unit drive mechanism is mechanically linked to said air turbine and said material turbine, wherein said air chamber and said material chamber are openly connected to said dispersal outlet tube, wherein said air turbine and said material turbine are configured to provide air pressure and material to said dispersal outlet tube.

According to an embodiment of the present invention, the integrated blowing device further comprises a housing unit.

According to an embodiment of the present invention, the housing unit further comprises a main housing body and a main housing cover configured to retain said material dispersal unit.

According to an embodiment of the present invention, the material dispersal unit is further comprised of a vehicle attachment means.

According to an embodiment of the present invention, the vehicle attachment means is configured to attach the material dispersal unit to a vehicle.

According to an embodiment of the present invention, the dispersal unit drive mechanism further comprises a drive shaft and a power conversion unit.

According to an embodiment of the present invention, the dispersal outlet tube further comprises an arrangement of baffles on the interior of said dispersal outlet tube.

According to an embodiment of the present invention, a method for dispersing material with pneumatic pressure is described and includes the steps of: generating an air stream, wherein said air stream is generated by an air turbine; delivering said air stream to a dispersal outlet tube, wherein said dispersal outlet tube utilizes said air stream to generate a Venturi effect; providing a material to said dispersal outlet tube, wherein a material turbine delivers said material to said dispersal outlet tube; combining said air stream with said material, wherein said Venturi effect cause said material to be absorbed by said air stream; dispersing said material via said dispersal outlet tube; wherein said material is carried by said air stream.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 shows a front isometric view of a material dispersal unit in accordance with an embodiment of the present invention;

FIG. 2 shows a rear isometric view of a material dispersal unit in accordance with an embodiment of the present invention;

FIG. 3 shows a front isometric view of a material dispersal unit in accordance with an embodiment of the present invention;

FIG. 4 shows a rear isometric view of a material dispersal unit in accordance with an embodiment of the present invention;

FIG. 5 shows an exploded view of a material dispersal unit in accordance with an embodiment of the present invention;

FIG. 6 shows a front isometric view of a material dispersal unit within a housing unit in accordance with an embodiment of the present invention;

FIG. 7 shows a front isometric view of a material dispersal unit in accordance with an embodiment of the present invention;

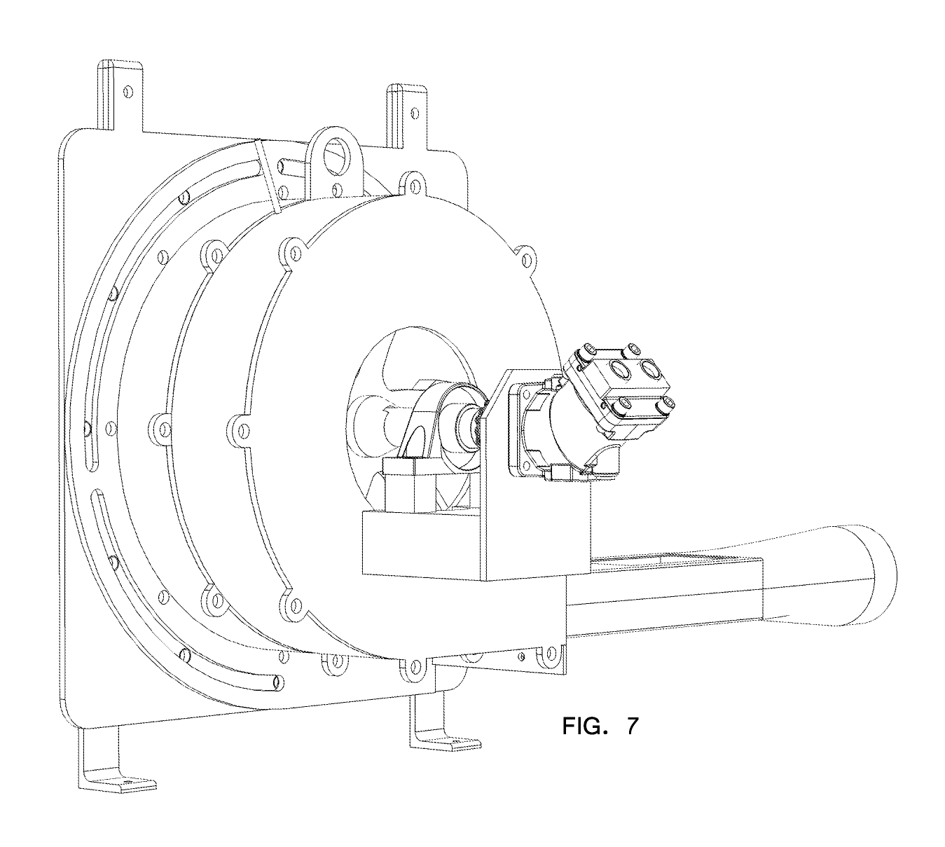

FIG. 8 shows a front isometric view of a material dispersal unit in accordance with an embodiment of the present invention;

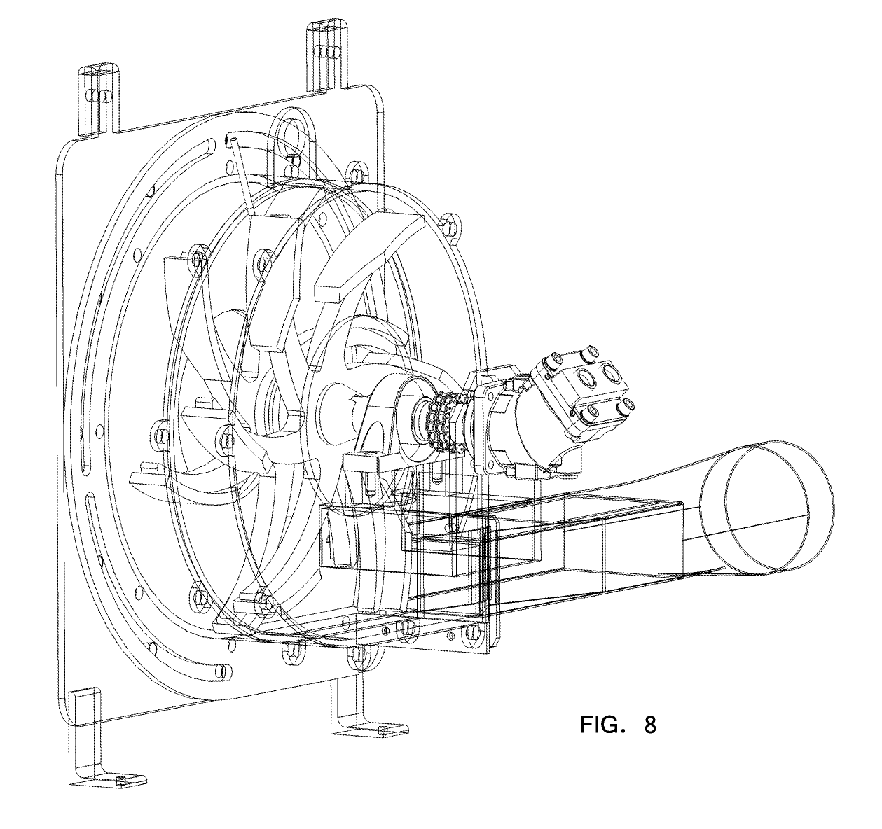

FIG. 9 shows a top view of a material dispersal unit in accordance with an embodiment of the present invention;

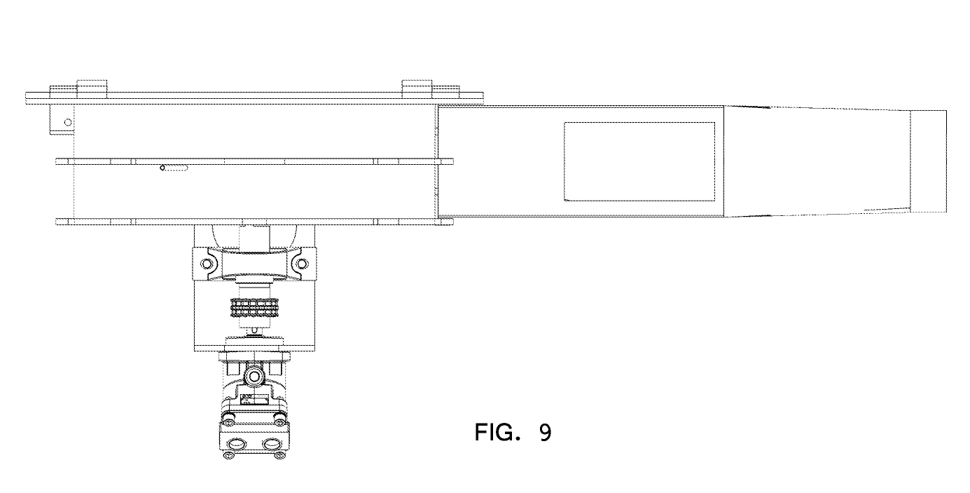

FIG. 10 shows a top view of a material dispersal unit in accordance with an embodiment of the present invention;

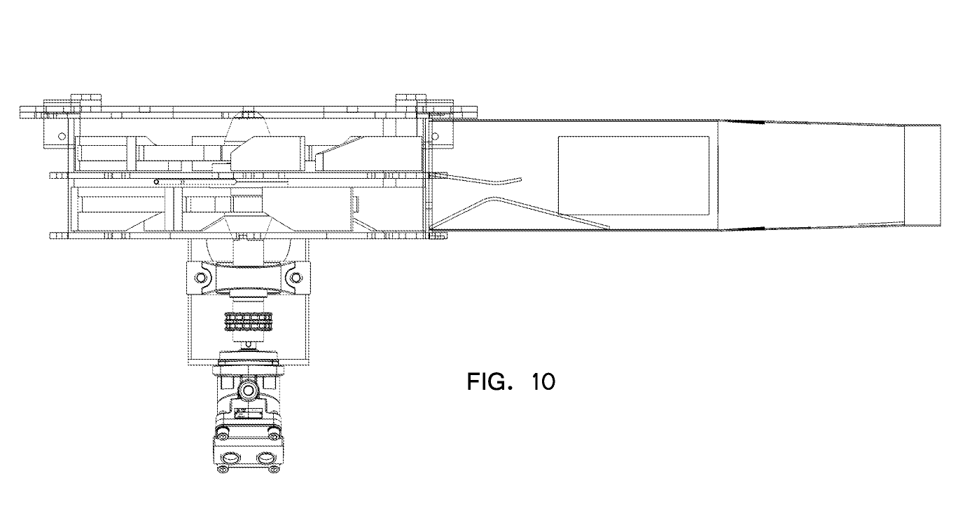

FIG. 11 shows a front view of a material dispersal unit in accordance with an embodiment of the present invention;

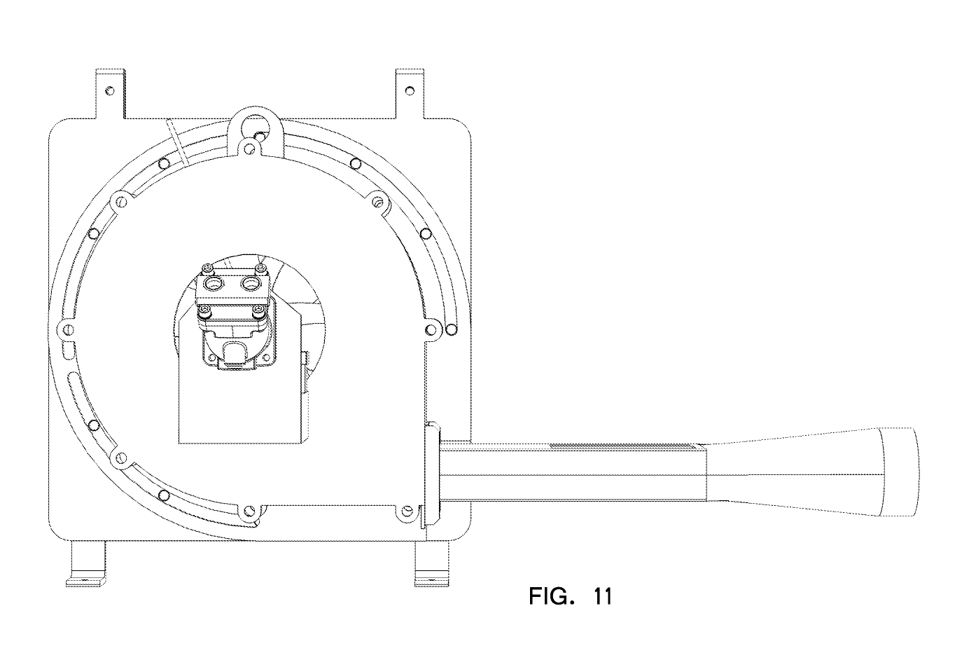

FIG. 12 shows a front view of a material dispersal unit in accordance with an embodiment of the present invention;

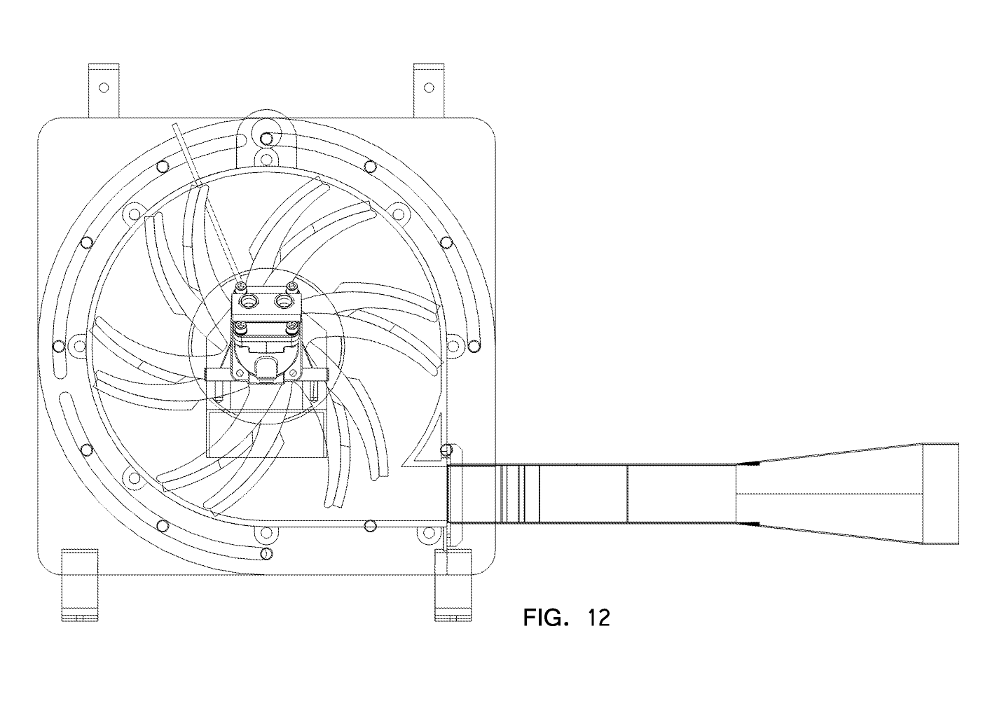

FIG. 13 shows a rear view of a material dispersal unit in accordance with an embodiment of the present invention;

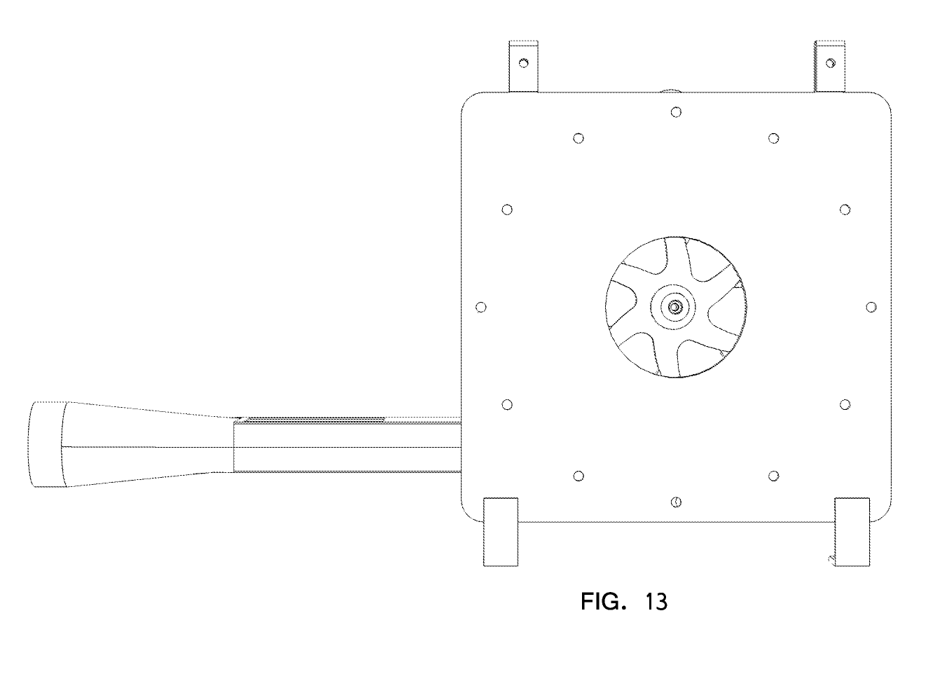

FIG. 14 shows a rear view of a material dispersal unit in accordance with an embodiment of the present invention;

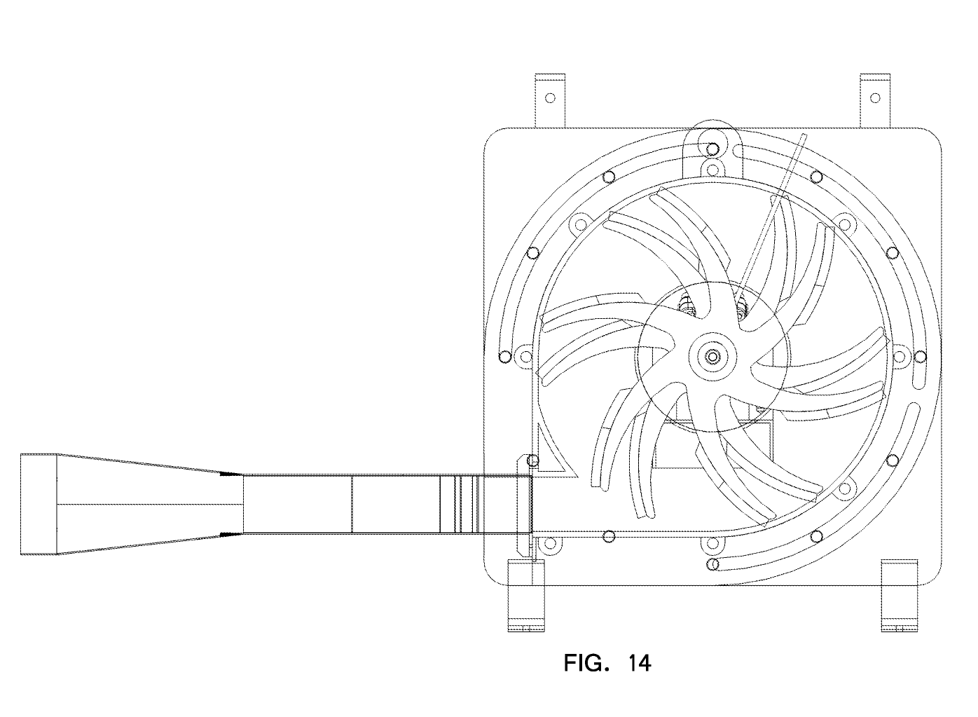

FIG. 15 shows a front isometric view of a material dispersal unit within a housing unit in accordance with an embodiment of the present invention;

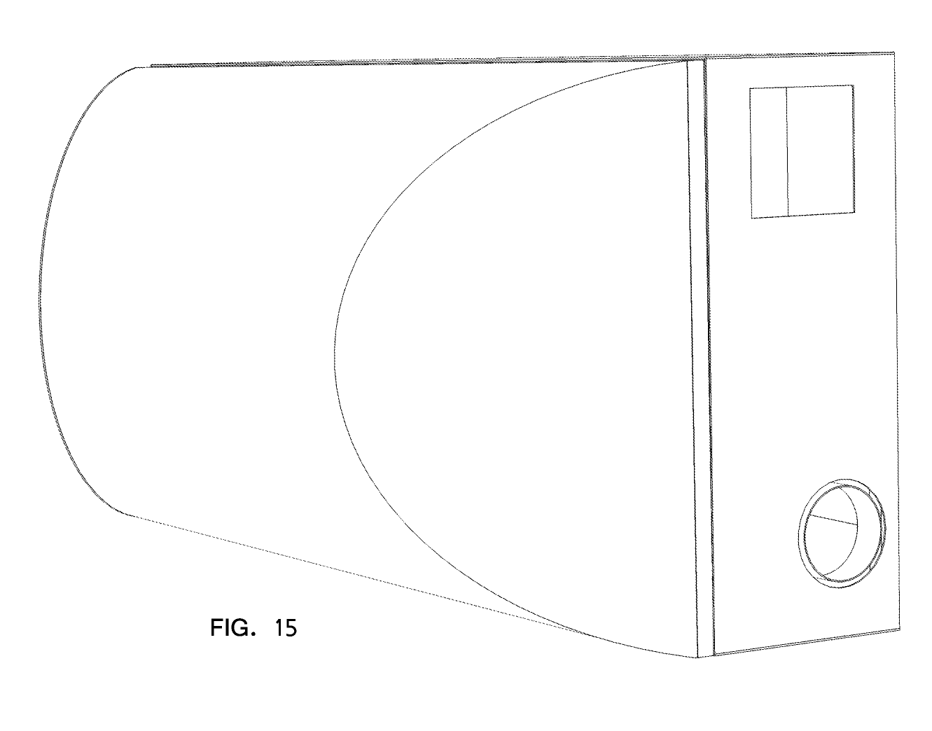

FIG. 16 shows a rear isometric view of a material dispersal unit within a housing unit in accordance with an embodiment of the present invention;

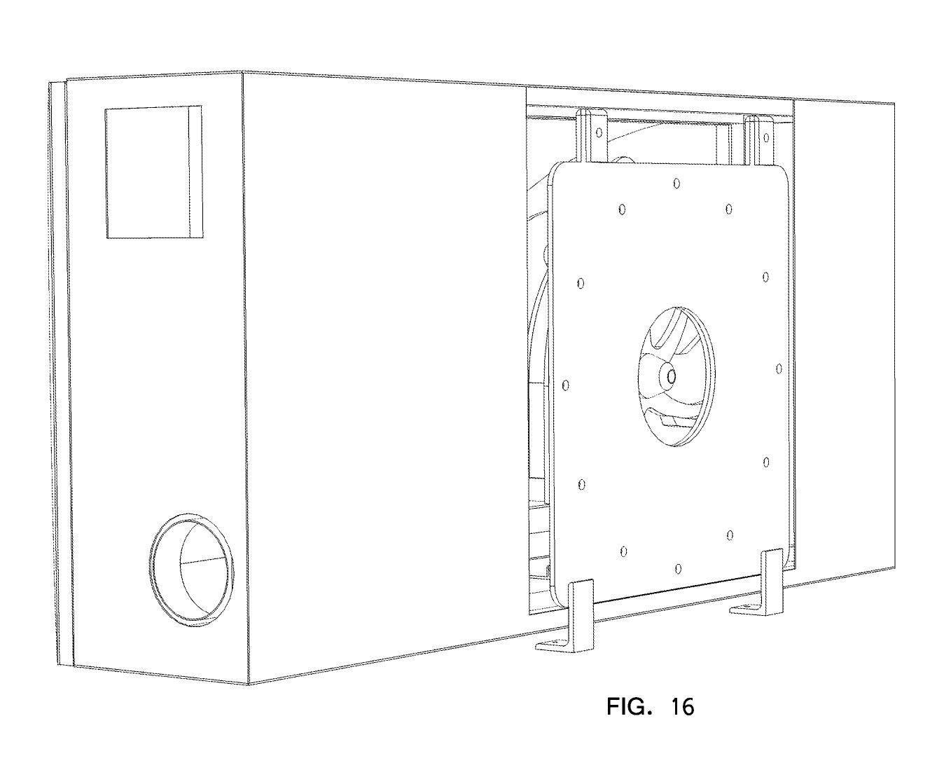

FIG. 17 shows a front isometric view of a material dispersal unit within a housing unit in accordance with an embodiment of the present invention;

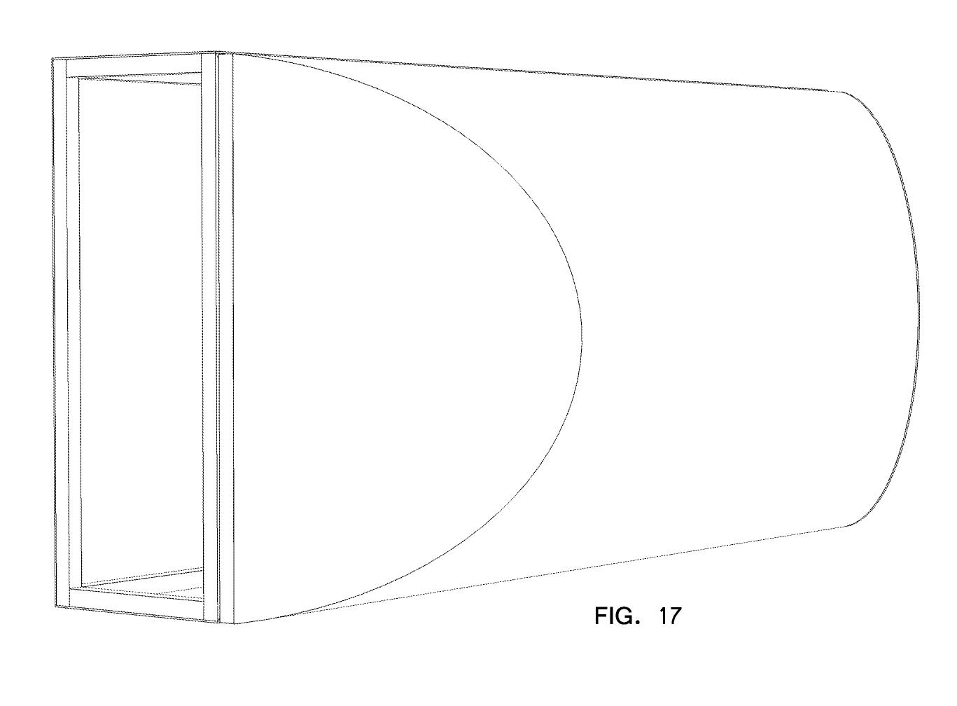

FIG. 18 shows a front isometric view of a material dispersal unit attached to an additional conveying unit in accordance with an embodiment of the present invention;

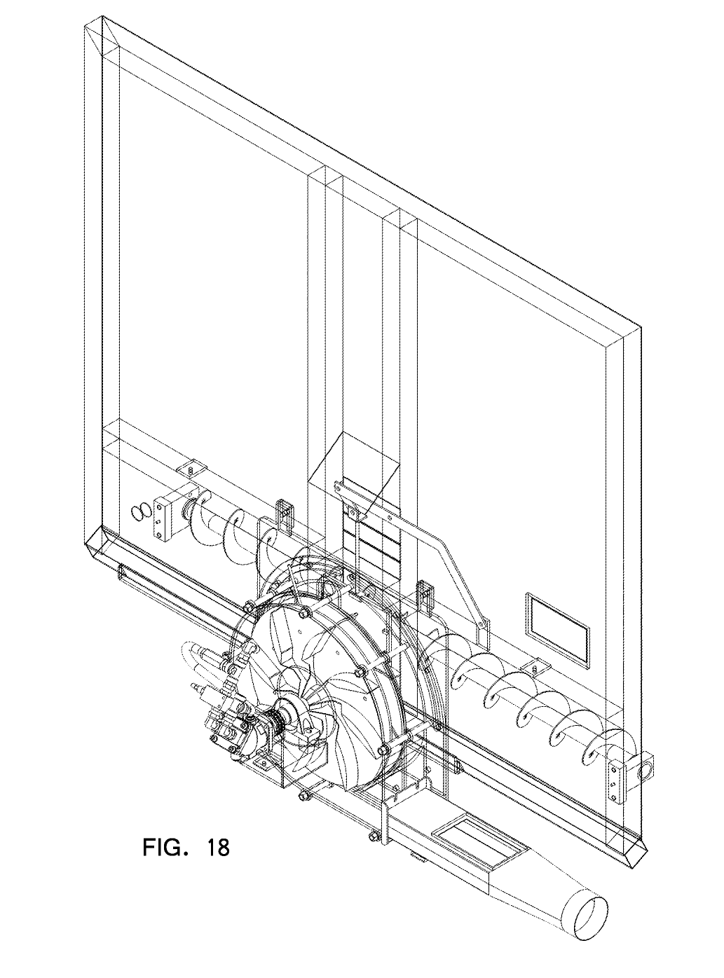

FIG. 19 shows a rear isometric view of a material dispersal unit attached to an additional conveying unit in accordance with an embodiment of the present invention.

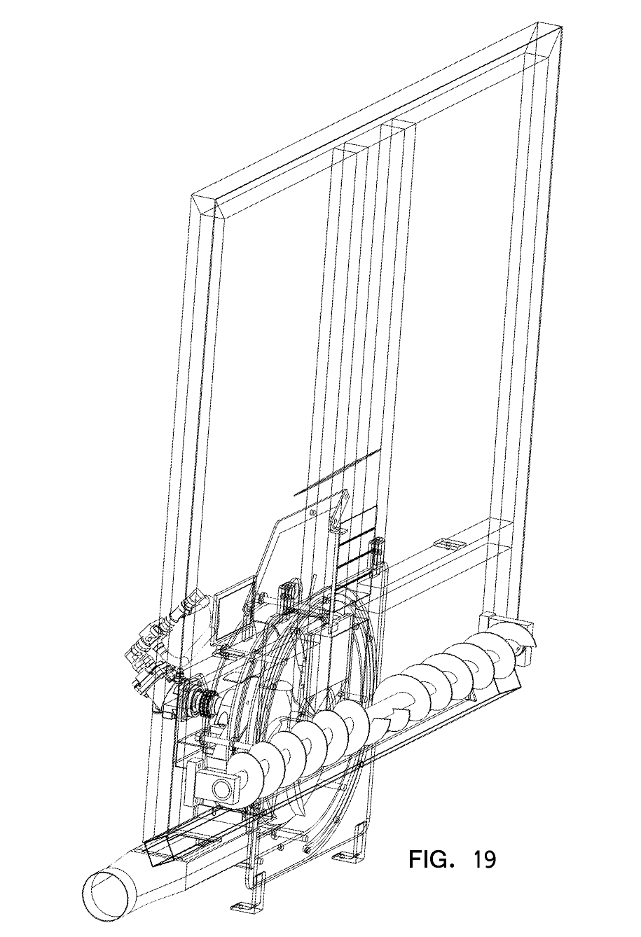

### DETAILED DESCRIPTION OF THE INVENTION

The present invention relates generally to systems and equipment for the handling and dispersal of bulk materials. Specifically, the invention relates to a pneumatic device for the handling of bulk materials which integrates a pneumatic power generating component and a material feeding component into a single device.

According to an embodiment of the present invention, the integrated blowing device is used to disperse bulk materials with pneumatic pressure. In a preferred embodiment, the device includes two chambers, each of which contains a high speed turbine. A first chamber and turbine is configured to generate air flow, while the second chamber and turbine is configured to handle material or other product that is to be dispersed. In the preferred embodiment, the two chambers are joined to a single outlet tube. The air stream generated by the first turbine creates a Venturi effect within the outlet tube that, along with the action of the second material handling turbine, causes material to be drawn into the outlet tube and combined with the air stream. The material can then exit the outlet tube as a part of the air stream and dispersed as required by the user. One of ordinary skill in the art would appreciate that the integrated blowing device could be adapted to function in a variety of form factors, and embodiments of the present invention are contemplated for use in any such form factor.

According to an embodiment of the present invention, an integrated blowing device may include a material dispersal unit. In a preferred embodiment, the material dispersal unit may include a dispersal unit derive mechanism, an air chamber, an air turbine, a material chamber, a material turbine, and a dispersal outlet tube. One of ordinary skill in the art would appreciate that a material dispersal unit could be configured with fewer components or additional components, and embodiments of the present invention are contemplated for use with any such configuration of components.

According to an embodiment of the present invention, a material dispersal unit may include a dispersal unit drive mechanism. In a preferred embodiment, the dispersal unit drive mechanism may include a drive shaft and a power conversion unit. In the preferred embodiment, the dispersal unit drive mechanism is mechanically linked to the air turbine and the material turbine. This linkage ultimately provides the rotational force that spins each of the turbines. One of ordinary skill in the art would appreciate that the dispersal unit drive mechanism could be operable in a number of configurations, and embodiments of the present invention are contemplated for use with any such configuration.

According to an embodiment of the present invention, the dispersal unit drive mechanism may include a power conversion unit. In a preferred embodiment, the power conversion unit coverts power received from a power source into mechanical force which is applied to the drive shaft. One of ordinary skill in the art would appreciate that there are many power conversion units that might be used in the dispersal unit drive mechanism, and embodiments of the present invention are contemplated for use with any such power conversion unit.

In a preferred embodiment of the present invention, the power source comprises an attachment to a vehicle, to which the material dispersal unit is attached. The power may come from an electrical or mechanical power source provided by the vehicle. For instance, power may come from an electrical attachment (e.g., electric drive AC/DC motors). In other embodiments, a power source could be direct drive (mechanical transmission or direct engine drive) or hydrostatic (hydraulic motor). In a preferred embodiment, the power source may be a hydraulic drive connection and the power conversion unit may be comprised of a hydraulic drive. This allows for the material dispersal unit to be utilized in conjunction with standard hydraulic fitted vehicles, converting them into efficient blowing systems.

In a preferred embodiment of the present invention, the power source is a hydraulic motor. This hydraulic motor provides rotational movement (e.g., torque and speed) based on oil flow and pressure generated by a hydraulic power unit. This hydraulic motor can be replaced by an electric motor that would directly drive the turbines. In an alternative embodiment, the power source can be a direct mechanical drive, whereby movement (e.g., speed and torque) are taken from an engine (e.g., gas/diesel) of a vehicle.

According to an embodiment of the present invention, the dispersal unit drive mechanism may include a drive shaft. In a preferred embodiment, the drive shaft provides a mechanical link between the power conversion unit and both the air and material turbines. The drive shaft applies a rotational force to the both the air turbine and the material turbine that causes the turbines to spin. One of ordinary skill in the art would appreciate that the drive shaft configurations that could be utilized in the dispersal unit drive mechanism, and embodiments of the current invention are contemplated for use with any such drive shaft. In a preferred embodiment, a sprocket/chain coupling (i.e., chain coupling) is used to connect the drive shaft from the turbine to the drive (e.g., hydraulic motor). One of ordinary skill in the art would appreciate that this chain coupling could be replaced by any coupling (providing it can withstand the torque and speed) or even a direct drive (e.g., hydraulic motor shaft matting the shaft), and embodiments of the present invention are contemplated for use with any type of coupling.

According to an embodiment of the present invention, a material dispersal unit may include an air chamber. In a preferred embodiment, the air chamber is a substantially circular chamber and is configured to house the air turbine. In the preferred embodiment, the air chamber is substantially sealed but for an air intake and an outlet to the dispersal outlet tube. The preferred configuration allows the air turbine to spin within the air chamber and generate air flow that is forced into dispersal outlet tube. The generated air flow is utilized to disperse material that enters the dispersal outlet tube. One of ordinary skill in the art would appreciate that the air chamber could function in a variety of configurations, and embodiments of the present invention are contemplated for use with any such configuration.

According to an embodiment of the present invention, a material dispersal unit may include an air turbine. In a preferred embodiment, the air turbine would be configured to fit inside of the air chamber and mechanically linked to the drive shaft through the center of the air turbine. The preferred embodiment of the air turbine may include six blades, each of which attach to the center of the air turbine. The rotation of the drive shaft causes the air turbine and the attached blades to spin, creating an air stream that is forced through an outlet in the air chamber and into the dispersal outlet tube. One of ordinary skill in the art would appreciate that the air turbine could be configured with more or less than six blades, and embodiments of the present invention are contemplated for use with any such number of blades.

According to an embodiment of the present invention, the shape of the turbine blades can be customized to meet various specifications. For instance, if the turbine blades need to be able to handle material, the “curve” of the turbine blades can be configured to allow matching the driving power to available power from the power source.

According to an embodiment of the present invention, a material dispersal unit may include a material chamber. In a preferred embodiment, the material chamber is a substantially circular chamber and is configured to house the material turbine. In the preferred embodiment, the material chamber is substantially sealed but for a material intake and an outlet to the dispersal outlet tube. The preferred configuration allows the material turbine to spin within the material chamber and feed material into dispersal outlet tube where it is dispersed with air stream generated by the air turbine. One of ordinary skill in the art would appreciate that the material chamber could function in a variety of configurations, and embodiments of the present invention are contemplated for use with any such configuration.

According to an embodiment of the present invention, a material dispersal unit may include a material turbine. In a preferred embodiment, the material turbine would be configured to fit inside of the material chamber and mechanically linked to the drive shaft through the center of the material turbine. The preferred embodiment of the material turbine may include six blades, each of which attach to the center of the material turbine. The rotation of the drive shaft causes the material turbine and the attached blades to spin, forcing the material to be dispersed through an outlet in the material chamber and into the dispersal outlet tube. One of ordinary skill in the art would appreciate that the material turbine could be configured with more or less than six blades, and embodiments of the present invention are contemplated for use with any such number of blades.

According to an embodiment of the present invention, the air chamber and the material chamber form a cohesive unit. In a preferred embodiment, the unit formed by the air chamber and the material chamber is substantially circular in shape. In a preferred embodiment, the wall between the chambers forms both the top wall of the air chamber and the bottom wall of the material chamber. The preferred embodiment is also configured to allow the drive shaft to pass (i.e., supported by a bearing) through the wall that separates the chambers and engage both the air turbine and the material turbine so that the rotational power can be provided to the turbines. In the preferred embodiment, the dispersal outlet tube is configured to join to the unit formed by the air chamber and the material chamber by connecting to the unit at an outlet on each chamber. One of ordinary skill in the art would appreciate that the air chamber and material chamber could be joined in a variety of configurations (including the air chamber feeding—via airflow—directly to the material chamber to increase the air pressure in the system—such as used in a staged turbine application for dense material where a higher air pressure is needed), and embodiments of the present invention are contemplated for use with any such configurations.

According to an embodiment of the present invention, a material dispersal unit may include a dispersal outlet tube. In a preferred embodiment, the dispersal outlet tube would be configured to connect to the air chamber and material chamber at an outlet located on the air chamber and an outlet the material chamber. The preferred embodiment of the dispersal outlet tube includes an dispersal tube inlet attached to the air chamber and material chamber and an dispersal tube outlet open to the outside of the integrated blowing device to allow for the dispersal of material. The preferred embodiment further includes an arrangement of baffles on the interior of the dispersal outlet tube. These baffles create a Venturi effect with the air stream created by the air turbine. The material turbine then provides the material to be dispersed to the dispersal outlet tube where the Venturi effect created by the baffles causes the material to be mixed with the air stream created by the air turbine. The mixed material and air streams then exit the dispersal outlet tube and are dispersed as desired by the user.

According to an embodiment of the present invention, an integrated blowing device might include a housing unit. In a preferred embodiment, the housing unit may include a main housing body and a main housing cover. One of ordinary skill in the art would appreciate that a housing unit could be configured with varied components, and embodiments of the present invention are contemplated for use with any such configuration.

According to an embodiment of the present invention, the housing unit of an integrated blowing device may include a main housing body. In a preferred embodiment the main housing body may be configured to retain the material dispersal unit. The preferred embodiment is primarily a rectangular-shaped box, with a right, back, top and bottom wall. The preferred embodiment is further configured to be open on the left side and open on the front side so that the front of the main housing body can engage with the main housing cover. Additionally, the right wall is formed with an opening for the dispersal outlet tube and the back wall is formed with an opening that allows the integrated blowing device to receive material. One of ordinary skill in the art would appreciate that the main housing body could be configured in any number of variations, and embodiments of the present invention are contemplated for use with any such variation.

According to an embodiment of the present invention, the housing unit of an integrated blowing device may include a main housing cover. In a preferred embodiment, the main housing cover is substantially domed cowl this open on the back and is configured to engage with the front of the main housing body. One of ordinary skill in the art would appreciate that the main housing cover could be designed in a variety of forms, and embodiments of the present invention are contemplated for use with any such form. In certain embodiments, the enclosure may be baffled and lined with acoustic foam—for soundproofing.

According to an embodiment of the present invention, the material dispersal unit may be attached to a vehicle via a vehicle attachment means. In preferred embodiment, the material dispersal unit may be mounted to a variety of vehicles, including, but not limited to, a dump truck, a trailer, containers or a tractor or similar piece of landscaping or agriculture equipment. In order to affect this attachment, the vehicle attachment means may be comprised of one or more of a bolt-on attachment, a screw on attachment, a locking means or any other means for attaching the material dispersal unit to a vehicle. One of ordinary skill in the art would appreciate that there are numerous type of vehicle attachment means that could be utilized with embodiments of the present invention, and embodiments of the present invention are contemplated for use with any such vehicle attachment means.

In certain embodiments, the vehicle attachment means may be comprised of a removable connection, allowing for the material dispersal unit to be attached and removed at the convenience of the operator.

In certain embodiments, the vehicle attachment means may further be comprised of a sealing component that creates an air tight seal between the vehicle and the material dispersal unit, preventing the escape of any material contained within the vehicle. The sealing component could be one or more of a rubberized seal, an O-ring, a sealant and an adhesive. One of ordinary skill in the art would appreciate that there are numerous types of sealing components that could be utilized with embodiments of the present invention and embodiments of the present invention are contemplated for use with any type of sealing component.

According to an embodiment of the present invention, the material dispersal unit may be mounted to the physical structure of a building or other static location. One of ordinary skill in the art would appreciate that the material dispersal unit could be mounted to a variety of static locations, and embodiments of the present invention are contemplated for use with any such mounting location.

### Exemplary Embodiment

According to an embodiment of the present invention, the integrated blowing device is useful for dispersing a variety of materials. In a preferred embodiment, the integrated blowing device may be used to disperse materials that include, but are not limited to, powders, soil, pellets, pebbles, straw, mulch, grains, and other agricultural, food, or industrial products. In the preferred embodiment, the air turbine generates an air stream that is forced into the dispersal outlet tube. Within the dispersal outlet tube is an arrangement of baffles that create a Venturi effect using the passing air stream. At the same time, the material turbine is feeding material into the dispersal outlet tube. The Venturi effect helps to draw and incorporate the material into the air stream so that the material may be carried by the air stream through the outlet of the dispersal outlet tube and dispersed as desired by a user.

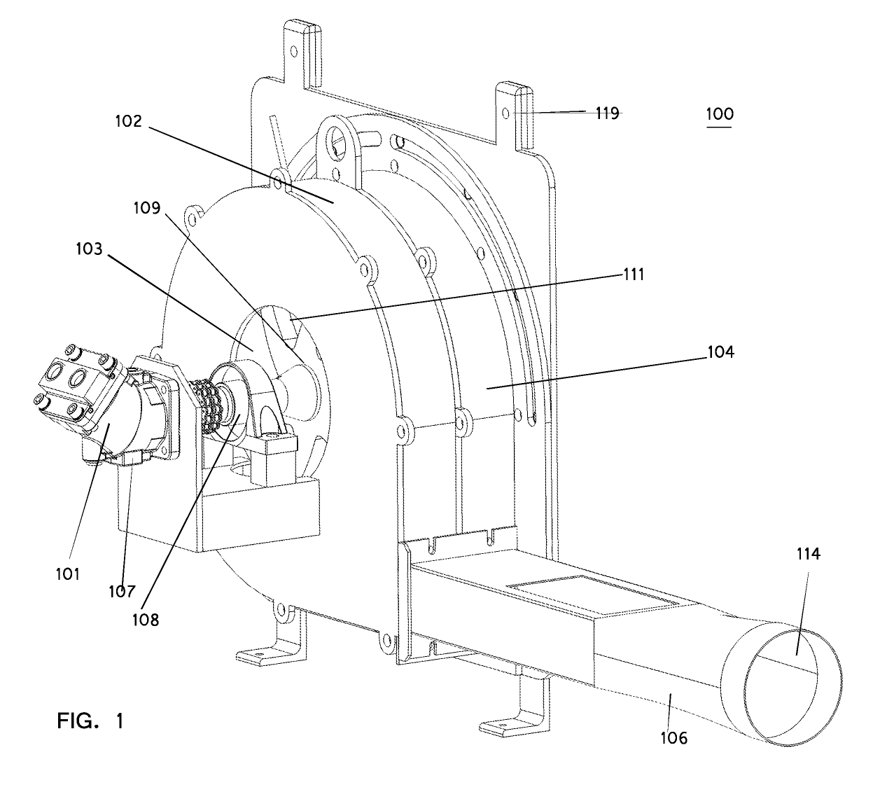

Turning now to FIG. 1, a material dispersal unit 100 in accordance with an embodiment of the present invention. In a preferred embodiment, the material dispersal unit 100 is primarily comprised of a dispersal unit drive mechanism 101, an air chamber 102, an air turbine 103, a material chamber 104, and a dispersal outlet tube 106. The air chamber 102 and the material chamber 104 substantially form one unit which is divided into the separate two chambers. The unit comprising the air chamber 102 and the material chamber 104 connects to the dispersal outlet tube 106. The dispersal unit drive mechanism 101 is comprised of a power conversion unit 107 connected to a drive shaft 108. The blades 111 are connected to the air turbine 103. The air turbine 103 is located inside of the air chamber 102 and rotates to draw air through the air intake 109 and out through the dispersal tube outlet 114. The material dispersal unit 100 further comprises a vehicle attachment means 119.

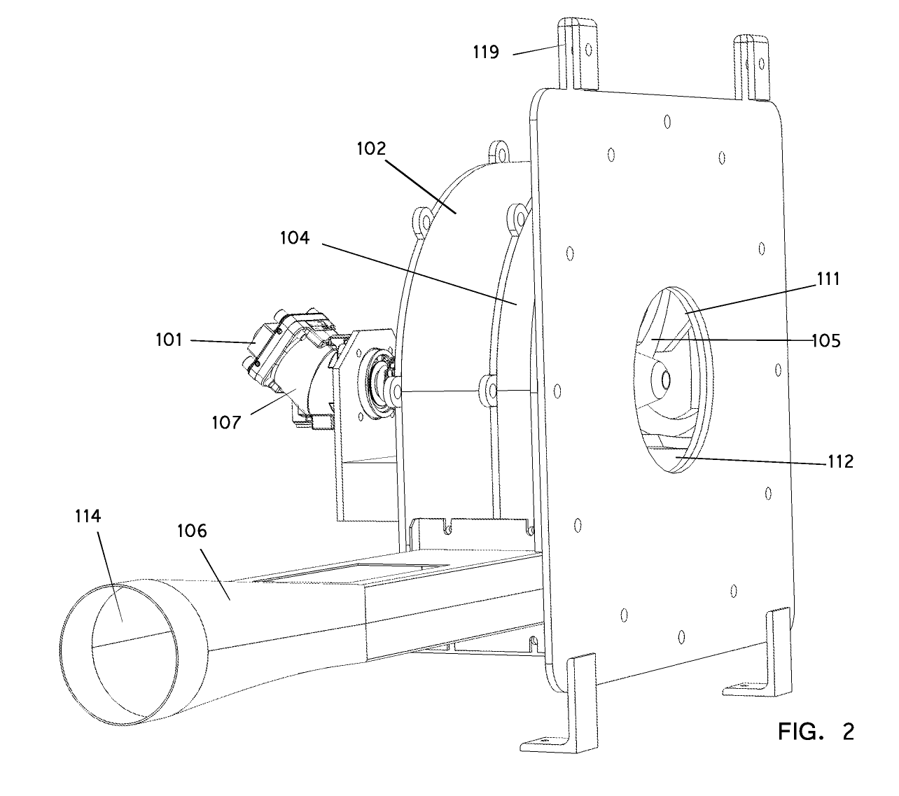

Turning now to FIG. 2, a material dispersal unit 100 in accordance with an embodiment of the present invention. In a preferred embodiment, the material dispersal unit 100 is primarily comprised of a dispersal unit drive mechanism 101, an air chamber 102, a material chamber 104, a material turbine 105, and a dispersal outlet tube 106. The air chamber 102 and the material chamber 104 substantially form one unit which is divided into the separate two chambers. The unit comprising the air chamber 102 and the material chamber 104 connects to the dispersal outlet tube 106. The dispersal unit drive mechanism 101 is comprised of a power conversion unit 107. The blades 111 are connected to the material turbine 105. The material turbine 105 is located inside of the material chamber 104 and rotates to draw material through the material intake 112 and out through the dispersal tube outlet 114. The material dispersal unit 100 further comprises a vehicle attachment means 119.

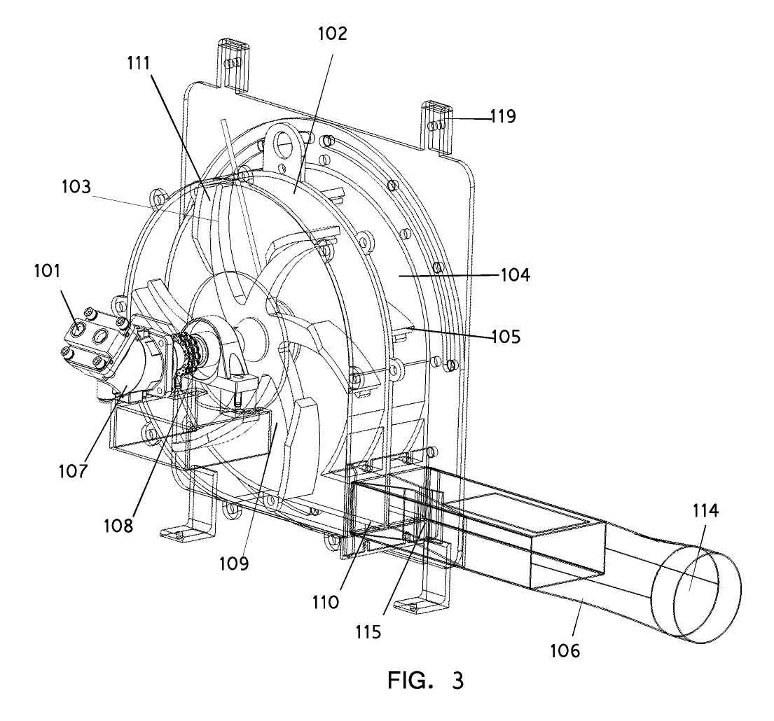

Turning now to FIG. 3, a material dispersal unit 100 in accordance with an embodiment of the present invention. In a preferred embodiment, the material dispersal unit 100 is primarily comprised of a dispersal unit drive mechanism 101, an air chamber 102, an air turbine 103, a material chamber 104, a material turbine 105, and a dispersal outlet tube 106. The air chamber 102 and the material chamber 104 substantially form one unit which is divided into the separate two chambers. The unit comprising the air chamber 102 and the material chamber 104 connects to the dispersal outlet tube 106 via an outlet 110. The dispersal outlet tube 106 is comprised of a dispersal tube inlet 113, a dispersal tube outlet 114, and baffles 115. The dispersal unit drive mechanism 101 is comprised of a power conversion unit 107 connected to a drive shaft 108. The blades 111 are connected to the air turbine 103. The air turbine 103 rotates to draw air through the air intake 109 and out through the dispersal tube outlet 114. The material dispersal unit 100 further comprises a vehicle attachment means 119.

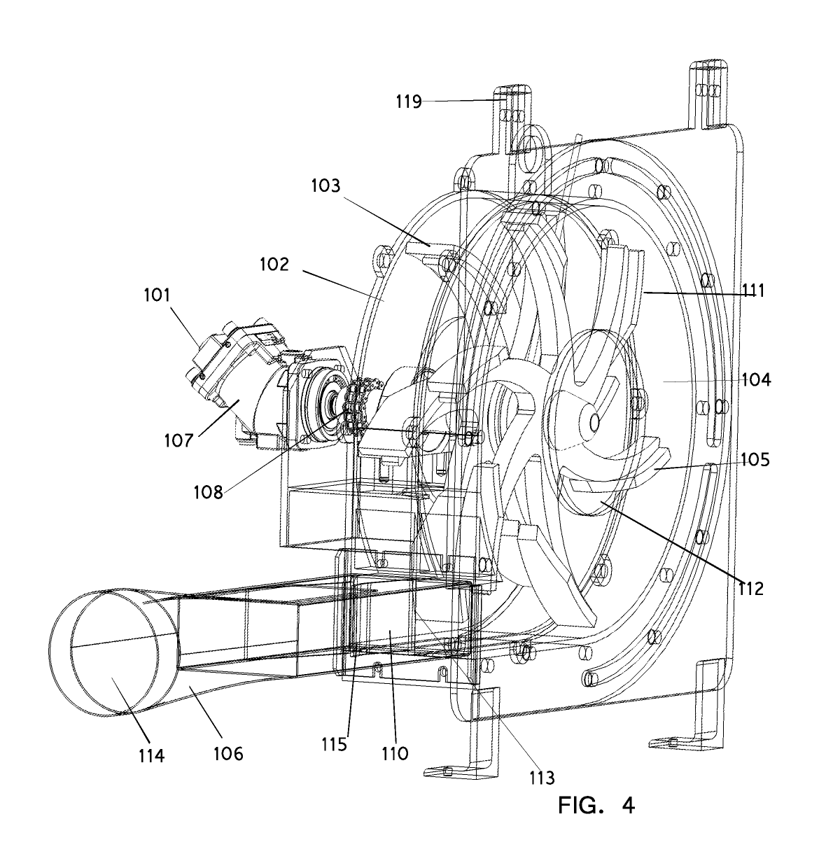

Turning now to FIG. 4, a material dispersal unit 100 in accordance with an embodiment of the present invention. In a preferred embodiment, the material dispersal unit 100 is primarily comprised of a dispersal unit drive mechanism 101, an air chamber 102, an air turbine 103, a material chamber 104, a material turbine 105, and a dispersal outlet tube 106. The air chamber 102 and the material chamber 104 substantially form one unit which is divided into the separate two chambers. The unit comprising the air chamber 102 and the material chamber 104 connects to the dispersal outlet tube 106 via an outlet 110. The dispersal outlet tube 106 is comprised of a dispersal tube inlet 113, a dispersal tube outlet 114, and baffles 115. The dispersal unit drive mechanism 101 is comprised of a power conversion unit 107 connected to a drive shaft 108. The air turbine 103 located inside of the air chamber 102 rotates to draw air through the air intake 109 and out through the dispersal tube outlet 114. The blades 111 are connected to the material turbine 105. The material turbine 105 is located inside of the material chamber 104 and rotates to draw material through the material intake 112 and out through the dispersal tube outlet 114. The material dispersal unit 100 further comprises a vehicle attachment means 119.

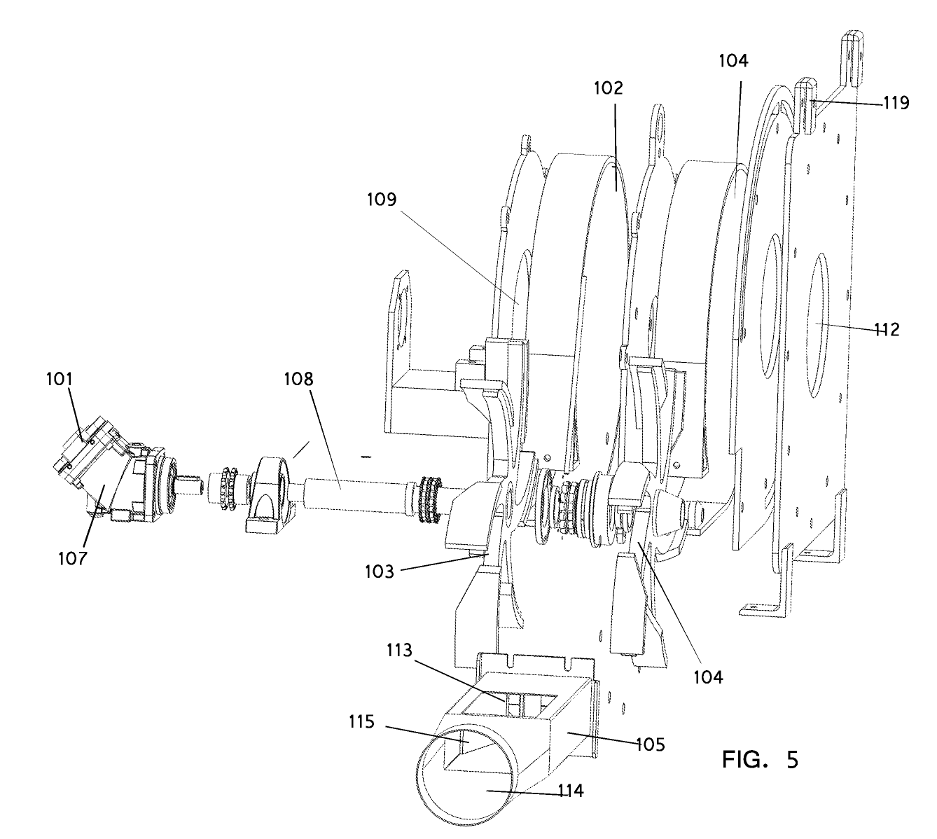

Turning now to FIG. 5, a material dispersal unit 100 in accordance with an embodiment of the present invention. In a preferred embodiment, the material dispersal unit 100 is primarily comprised of a dispersal unit drive mechanism 101, an air chamber 102, an air turbine 103, a material chamber 104, a material turbine 105, and a dispersal outlet tube 106. The dispersal unit drive mechanism 101 is comprised of a power conversion unit 107 connected to a drive shaft 108. The drive shaft 108 connects to the air turbine 103 and the material turbine 105. The air turbine 103 and the material turbine 105 each include blades 111. The air turbine 103 and the material turbine 105 are located within the air chamber 102 and the material chamber 104, respectively. The air chamber 102 and the material chamber 104 are further comprised of air intake 109 and a material intake 112, respectively. The dispersal outlet tube 106 connects to the unit comprised of the air chamber 102 and the material chamber 104. The dispersal outlet tube 106 is further comprised of a dispersal tube inlet 113, a dispersal tube outlet 114, and baffles 115. The material dispersal unit 100 further comprises a vehicle attachment means 119.

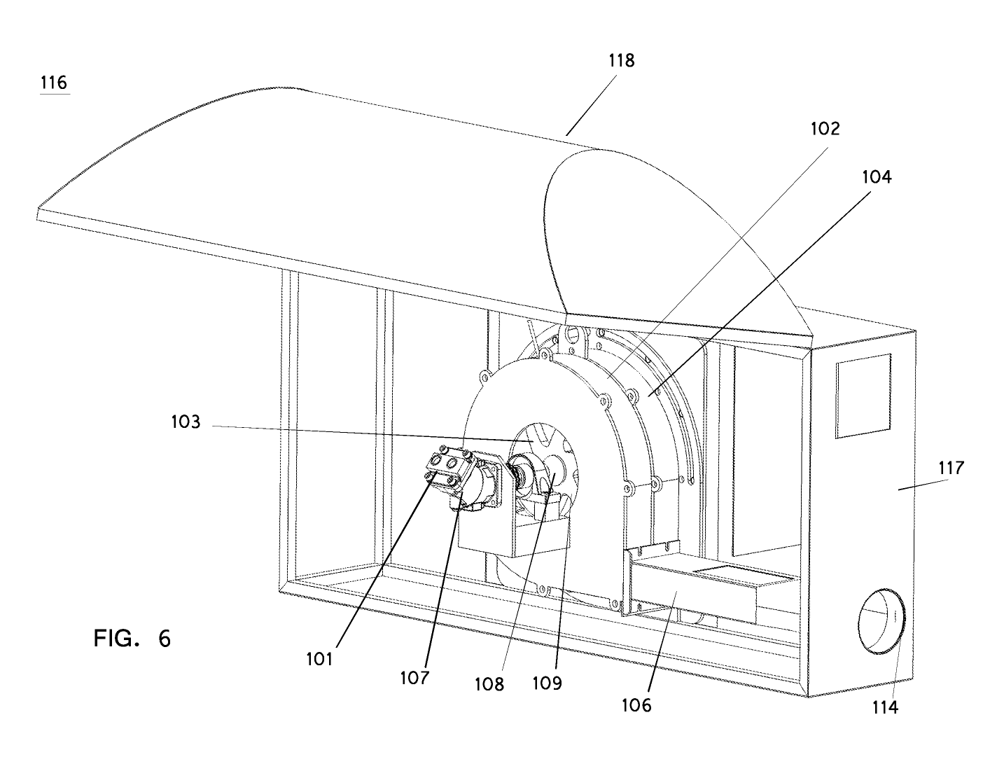

Turning now to FIG. 6, a material dispersal unit 100 mounted within a housing unit 116 in accordance with an embodiment of the present invention. In a preferred embodiment, the housing unit 116 is comprised of a main housing body 117 connected to a main housing cover 118. The material dispersal unit 100 is mounted within the main housing body 117. The main housing cover 118 can detachably engage with the main housing body 117 to enclose the material dispersal unit 100.

The features and advantages of the present invention described in the embodiments are presented for illustrative purposes only and should not be construed to limit the scope of the invention. Many modifications and variations of these embodiments are possible. While the invention has been thus described with reference to the embodiments, it will be readily understood by those skilled in the art that equivalents may be substituted for the various elements and modifications made without departing from the spirit and scope of the invention. It is to be understood that all technical and scientific terms used in the present invention have the same meaning as commonly understood by one of ordinary skill in the art to which this invention belongs.

1. An integrated blowing device, said device comprising of:
a material dispersal unit, comprising a,
dispersal unit drive mechanism,
an air chamber,
an air turbine,
a material chamber,
a material turbine,
and a dispersal outlet tube,
wherein in said dispersal unit drive mechanism is mechanically linked to said air turbine and said material turbine,
wherein said air chamber and said material chamber are openly connected to said dispersal outlet tube,
wherein said air turbine and said material turbine are configured to provide air pressure and material to said dispersal outlet tube.

2. The integrated blowing device of claim 1, wherein said integrated blowing device further comprises a housing unit.

3. The integrated blowing device of claim 2, wherein said housing unit further comprises a main housing body and a main housing cover configured to retain said material dispersal unit.

4. The integrated blowing device of claim 1, wherein said material dispersal unit further comprises a vehicle attachment means.

5. The integrated blowing device of claim 4, wherein said vehicle attachment means is configured to attach said material dispersal unit to a vehicle.

6. The integrated blowing device of claim 1, wherein said dispersal unit drive mechanism further comprises a drive shaft and a power conversion unit.

7. The integrated blowing device of claim 6, wherein said power conversion unit is attached to a hydraulic component of a vehicle and is configured to convert hydraulic power into mechanical energy to drive said drive shaft.

8. The integrated blowing device of claim 1, wherein said dispersal outlet tube further comprises an arrangement of baffles on the interior of said dispersal outlet tube.

9. A method for dispersing material with pneumatic pressure, said method comprising the steps of:
generating an air stream, wherein said air stream is generated by an air turbine;
delivering said air stream to a dispersal outlet tube, wherein said dispersal outlet tube utilizes said air stream to generate a Venturi effect;
providing a material to said dispersal outlet tube, wherein a material turbine delivers said material to said dispersal outlet tube;
combining said air stream with said material, wherein said Venturi effect cause said material to be absorbed by said air stream;
dispersing said material via said dispersal outlet tube; wherein said material is carried by said air stream.
